(19) United States
(12) Patent Application Publication
(10) Pub. No.: US 2007/0226117 A1
(43) Pub. Date: Sep. 27, 2007

(54) Certification program to facilitate the aquisition of investment personal property

(76) Inventor: Paul E. Paray, Ho-Ho-Kus, NJ (US)

Correspondence Address: Paul E. Paray, 722 Hollywood Avenue, Ho-Ho-Kus, NJ, 07423, US

(21) Appl. No.: 11/716,780

(22) Filed: Mar. 12, 2007

Related U.S. Application Data
(60) Provisional application No. 60/781,142, filed on Mar. 13, 2006.

(51) Int. Cl. G06Q 40/00

(52) U.S. Cl. 705/36 T

(57) ABSTRACT

Information is obtained that leads to the acquisition of certified personal investment property for a tax-beneficial exchange. An intranet and web site shows items certified under the certification program which are available for exchange. At least one of the items is selected for viewing. The item is displayed on a display device for viewing. If both exchanging parties agree, the certified item is exchanged between the parties in a tax-beneficial exchange.

### CROSS REFERENCE TO RELATED APPLICATIONS

This application claims priority from U.S. Provisional Patent Application Ser. No. 60/781,142 filed on Mar. 13, 2006 currently pending, the contents of each which is herein fully incorporated by reference.

### FIELD OF THE INVENTION

The present invention relates to methods and systems for owners of investment personal property (such as art, jewelry and fine wine) as well as such property which is also a capital asset (such as stamps and coins) to locate and obtain similar property, and more particularly to a method and system for ensuring that such owners receive greatly expanded opportunities for obtaining like-investment property via the use of a certification program.

### BACKGROUND OF THE INVENTION

As recognized by Unity Marketing (Reinholds, Pa.), collectors collect for three reasons: (1) they have a strong emotional attachment to the things they collect; (2) they view their collections as a reflection of their personal identity; and (3) they have a rational interest in the quality, exclusivity, or value of the things they collect. Having such a close affinity for the pieces they collect, it is not easy for collectors of highly-valued objects such as sculptures, paintings, furniture, and rare wine to part with their personal treasures—even when such collections are ostensibly conducted strictly with an investment objective in mind.

Accordingly, it is no surprise that collectors of investment property rather than “trading” or systematically selling off their items, often end up only adding to their collections. Such a strategy is costly but is likely not of major concern to the super-affluent market. Indeed, according to the Mendelsohn Affluent Survey, in which Mendelsohn Media Research, Inc. (New York, N.Y.) interviews over 40,000 affluent Americans, the super-affluent category (those with household incomes of $250,000 or more) outspends the less affluent in artwork, jewelry, and collectibles by up to 400 percent. Moreover, the size of this group is continuing to grow at a rapid rate. According to a Wall Street Journal report citing findings by Merrill Lynch and CapGemini, the number of people in the US with more than $1 million in financial assets grew 10% in 2004 to about 2.5 million. The present invention, inter alia, placates the concerns of super-affluent collectors looking to obtain like-kind personal investment property such as fine art by protecting confidentiality and insuring against physical loss, fraud, and adverse tax rulings.

Contrary to this steady growth in the drivers behind private collections, museums have seen little recent growth. According to a Wall Street Journal report citing the American Association of Museums, attendance at museums has been flat over the past three years. (Wall Street Journal, Feb. 10, 2006, W10).

Combined with lower federal funding, museums must now seek creative ways to monetize their assets. To that end, the present invention is also a means for museums to efficiently deaccession pieces in order to obtain new pieces; and thereby attract new visitors, members, and donors.

More specifically, the present invention is a means of extracting value from a museum's treasure trove of hidden art without disrupting the existing business model of these typically non-for-profit organizations. As reported in the Wall Street Journal, the Yale University Art Gallery only displays 2% of its 185,000 pieces; the J. Paul Getty Museum only displays 35% of its 110, 622 pieces; and the Museum of Fine Arts in Boston only displays 4% of its 450,000 artifacts and artworks. In fact, twelve of the nation's largest museums display only 1% to 50% of the art in their collections. (Wall Street Journal, Feb. 10, 2006, W10).

Set forth below is additional background information that relates to distinct components of the present invention.

1. Tax Implications of Collecting Investment Property

Under US federal law, a capital gain is based on the increase in the value of an investment property such as an oil painting over its value when it was first purchased, i.e., its “basis”. Capital gains are only taxable after the asset is actually sold and only at a specific capital gains tax rate. Although the capital gains tax rate on sold long-term investment property such as fine art is lower than both the estate tax and income tax, it currently stands at a not insignificant rate. Accordingly, should a collector choose to deaccession a highly-appreciated piece from her collection by way of a sale, the tax impact would be immediate and potentially onerous.

Moreover, in other countries, the tax rate on the sale of fine art can be even more pernicious to a collector's financial well being. For example, beginning on Jan. 1, 2006, art sellers living in European Union (EU) member countries have been subject to a tax levy, known as droit de suite, which is paid by the seller of a work of art to the artist or their heirs up to 70 years after the artist's death. Although this new levy greatly benefits an artist's heirs, it obviously also has a major negative impact on the sale of art in EU member countries. Similarly, it was reported by the BBC in 2002 that a previous EU-wide tax on imported artworks drove as much as seven percent of the art market to the US.

2. Like-Kind Exchanges of Investment Property

Unlike with a sales transaction, certain exchanges of property are not taxable under federal US law. Pursuant to IRS Section 1031, any gain from a “like-kind” exchange is not recognized as a taxable event and any loss cannot be deducted. The gain or loss is only recognized when the owner actually sells or otherwise disposes of the property. As reported in the Wall Street Journal, Deloitte & Touche USA LLP estimates that the total value of all property involved in these IRS Section 1031 “like-kind” exchanges jumped to $175 billion in 2003 compared to $90 billion in 1999. (Wall Street Journal, Dec. 29, 2005, D1). In fact, the Federation of Exchange Accommodators exists as a national trade association organized to represent professionals who help conduct like-kind exchanges under IRS Section 1031. It is generally recognized that the greatest difficulty in creating these tax-deferred exchanges is finding suitable property to trade.

Although there was never any overt prohibition against the use of Section 1031 for “like-kind” exchanges of personal investment property such as fine art, real-property exchanges constitute nearly all IRS Section 1031 exchanges. There have been, however, several recent highly publicized IRS Section 1031 exchanges of personal investment property. For example, in November 2005, a block of 4 “Inverted Jenny” stamps bought in October 2005 for nearly $3 million were exchanged for an 1868 one cent “Z Grill” stamp bought in 1998 for $935,000 and valued at $3 million at the time of the exchange. As well, in late 2005, the baseball bat used by Joe DiMaggio during his 1941 56-game hitting streak was exchanged pursuant to IRS Section 1031 for a broad collection of baseball memorabilia, including photos of Mickey Mantle. (Wall Street Journal, Dec. 29, 2005, D1). This baseball-themed exchange illustrates that IRS Section 1031 exchanges can be for items with very different physical properties so long as they have a common character or “common theme”.

Of relevance to the present invention are the following characteristics of a deferred tax transaction under US tax law:
i. If a collector acquires property in a like-kind exchange, the basis of that property is the same as the basis of the property transferred.
ii. Exchange expenses such as closing costs, e.g., attorney fees and title insurance, may be considered part of the basis should an exchange be disqualified and the transaction be considered a sale.
iii. Like-kind exchanges are properties of the same nature or character, even if they differ in grade or quality.
iv. The exchange of personal property for similar personal property is an exchange for like property.
v. The transaction must be an exchange (that is, property for property) rather than a transfer of property for money used to buy replacement property.
vi. A qualified intermediary can be used to affect a like-kind property exchange. A qualified intermediary is a person who enters into a written exchange agreement to acquire and transfer property and to acquire the replacement property and transfer it.
vii. When making a “deferred like-kind” exchange, a person can transfer ownership in property to the qualified intermediary up to 45 days prior to the identification of the property to be exchanged.
viii. A qualified intermediary cannot be an agent such as broker or investment banker of either party to the exchange or “related” to a party to the trade. Various entities are deemed related when there are common ownership interests that exceed 10%. For example, an individual and corporation are deemed related if the individual directly or indirectly owns more than 10% in value of the outstanding stock of the corporation.

3. Tax Indemnity Insurance Products

For over a decade, insurance companies have been selling insurance products that indemnify against an insured's contingent tax loss. Although not a commonly marketed feature, existing tax indemnity insurance products can potentially provide indemnification should the IRS deem a purported deferred like-kind exchange disqualified. Tax indemnity products can provide the following coverages: (1) indemnification against an adverse tax ruling that would create a liability under federal, state, local or non-US law; (2) the “gross up” of taxes with respect to the tax indemnity insurance proceeds; (3) interest and civil fines and penalties; and (4) expenses incurred in contesting an adverse tax ruling.

These tax indemnity products also have the following common characteristics:
i. The premium is largely based on the strength or weakness of the legal basis for the transaction.
ii. Given the focus given to the legal basis for the insured transaction, a legal tax opinion is necessary to outline the facts of the transaction and an opinion regarding the potential exposures.
iii. Given the necessity of a legal opinion and the careful underwriting scrutiny of the opinion, it can take weeks to underwrite and bind coverage.
iv. Significant additional documentation, including but not limited to prior audits, related IRS correspondence, and tax returns, are often also required during the underwriting process.
v. Given the use of outside counsel to assist in underwriting a risk, the applicant is often charged upwards of $50,000 as an “underwriting fee”.
vi. The minimum premiums for such a product can exceed $200,000 and is often a much greater amount.

4. Fine Art and Collectible Insurance Products

Soon after the US federal tax laws changed in the mid-1980's to require that an art loss tax deduction be based on the original acquisition price rather than the appreciated value of the item at the time of the loss, the US fine art insurance industry was born. Although there are several types of insurance polices for fine art and collectibles, the type of policy that most resembles the present invention's property insurance feature is the “scheduled” all-risk coverage.

A “scheduled” all-risk insurance product for fine art and collectibles can have the following characteristics;
i. Coverage provided for 100% of the stated insured value without a deductible or depreciation charge.
ii. The replacement cost if there is an increase in value can be higher than 100% of the stated value.
iii. Coverage is for loss that occurs anywhere in the world.
iv. Appraisals of the covered items are only required if the item is valued at over a set amount, usually over $100,000, and are generally required every three to five years.
v. Coverage is provided for loss or damage occurring during the transportation or installation of the piece.

5. Title Insurance for Art and Collectibles

For over 100 years, title insurance has been sold to cover the marketability of title to real property. Traditionally, title insurers provide the purchaser and lender with “no-fault” protection against risks associated with real estate transactions, including:
Defects in title
Adverse Claims made against property
Fraud and forgery in title documents
Liens or other encumbrances
Survey errors

A title policy can insure the lender for the mortgaged amount and, in effect, guarantee a return on the loan investment should a title problem arise after the purchaser takes possession. Most lenders require the purchaser to pay for a title policy to indemnify the lender. The typical title insurance product for real estate has the following characteristics:
i. Statutory based premium;
ii. Coverage for title defects resulting from negligence of the closing attorney;
iii. Claims expenses incurred in defending a title Claim;
iv. Exclusions based on encumbrances or other defects discovered during various title searches.

Although not yet a commonly marketed insurance product, title insurance for fine art has been approved for sale in New York State so long as the title insurer complies with all laws particular to title insurance. According to an Oct. 16, 2003 General Counsel Opinion issued on behalf of the State of New York Insurance Department, title insurance for fine art does fall within the ambit of title insurance and may be offered for sale in New York State. The main proviso is that an admitted title insurer and not another type of insurance company actually sell the coverage. New York's recognition of the availability of title insurance for fine art is significant given that according to a report by the BBC, the European Fine Art Foundation estimates that in 2003 more than 60% of sales exceeding 200,000 euros were made in New York. This is not surprising given the EU's significant tax burden on fine art sales.

The potential need for title insurance on fine art and collectibles becomes more readily apparent when evaluated in the context of recent litigation instituted to settle the title to art works. For example, the U.S. District Court for the District of Columbia is currently hearing a case brought by heirs of Russian artist Kazimir Malevich against an Amsterdam museum. The heirs are seeking a declaratory ruling that the Amsterdam museum's purchase of the paintings in the 1950's was invalid. The case is being heard in the US because the Amsterdam museum lent the works to a US museum for exhibit and the suit was instituted prior to the return of the works to Amsterdam. See Malewicz et. al. v. City of Amsterdam, (D.C. Civ. Action No. 04-0024).

6. Appraisal of Fine Art and Collectibles

There are various trade organizations for fine art and collectible appraisers, including the Appraisers Association of America, the American Society of Appraisers, and the International Society of Appraisers. These organizations provide an ethical framework in which their members must comply or risk loss of membership privileges. Moreover, accredited appraisers often employ objective standards, including the Uniform Standards of Professional Appraisal Practice. The preferred embodiment of the present invention requires that appraisals utilized as part of the certification program be from an accredited appraiser.

Although there are several types of appraisal methods used when valuing personal property, for purposes of the present invention, there are two forms of appraisals that are relevant: (1) the Fair Market Valuation typically used for tax purposes and (2) the Replacement Value Valuation which determines the amount one can receive in the event of a loss under a property policy.

In addition to a monetary valuation, a fine art or collectible appraisal should generally contain the following minimum information (stored digitally along with digital photographs of the appraised item):
i. Title, Subject, and Date
ii. Name of Maker or Manufacturer or Attributed School (if available)
iii. Description of structure and material (e.g., fiberglass sculpture or gold coin)
iv. Grade (if relevant)
v. Dimensions
vi. Unique Markings or Distinguishing Features
vii. Other Relevant Information

7. Certification Program for Investment Property

According to US trademark law, “a certification mark is any word, name, symbol, device, or any combination, used, or intended to be used, in commerce with the owner's permission by someone other than its owner, to certify regional or other geographic origin, material, mode of manufacture, quality, accuracy, or other characteristics of someone's goods or services, or that the work or labor on the goods or services was performed by members of a union or other organization.” See 15 USC § 1227 Unlike collective trademarks that may only be used by particular members of the organization that owns them, certification marks may be used by anybody who complies with the standards that are predetermined by the owner of the certification mark.

In effect, a certification mark acts as a guarantee that goods or services bearing the mark meet a certain standard or possess a particular characteristic. Good examples of quality certification marks include the “UL Listed” mark, the “Woolmark” mark, and the “AP” (Approved Product) mark for art supplies. Underwriters Laboratories (UL) allows manufacturers to use its UL Listed service mark if the manufactured electrical products have been approved by UL. The “Woolmark” certification mark is used to identify clothing containing wool. And, according to the Art & Creative Materials Institute (ACMI), the “AP seal” placed on manufactured art materials indicates that the products are “certified by ACMI to contain no materials in sufficient quantities to be toxic or injurious to humans or to cause chronic or acute health problems.” In fact, the AP Seal has a reference that it “Conforms to ASTM D-4236” which is itself a certification that the product conforms to a third-party standard, namely ASTM (American Society for Testing and Materials) labeling standards.

In addition to the above trademark approach to a certification process, there are various other means of “certifying” the quality of a service or product. For example, the term “protected designation of origin” (PDO) is a geographical indication defined under European Union Law that is used to certify regional foods. Under PDO regulations, certain designations, i.e., Parmigiano Reggiano and Champagne, can only be labeled as such if they come from these respective regions. This system is similar to the Appellation d'Origine Contrôlée certification used for French wine.

Overall, there is a fine line, however, between a “certification” and the actual “grading” of a product or service. For example, although the Gemological Institute of America (GIA) provides its “grading reports” on diamonds, it is very clear to point out that no one is entitled to use the GIA mark to state GIA has “certified” a diamond. The phrase “GIA Certified Diamonds” is expressly deemed an unauthorized use of the GIA mark. As stated in its online “Copyrights and Trademark Notices”, “[i]t is an unauthorized use of GIA's name to imply that GIA and/or its subsidiaries directly or indirectly certify, sponsor, or approve any individual or private business including its employees, products, services, or prices. Our policy is clear: GIA does not certify any person, business, or thing. Therefore, GIA does not authorize use of the word “certify” or any derivative in conjunction with the GIA name and products in advertising.” http://www.gia.edu/about/42/copyright_trademarks.cfm

The present invention's certification program is neither based on a certification trademark that leaves the owner with limited discretion after issuance or a subjective grading system that works strictly outside the confines of a uniform certification process. The present invention is actually more akin to a program for becoming a “certified vendor” or a “vendor certified technician” in that it is closely aligned with generating new business for those who are involved, directly or indirectly, with the certification program. Moreover, a vendor/manufacturer certification program, as with the present invention, seeks to improve upon the level of service in the products related to the program.

Although far removed from the intent of the present invention, a vendor certification program recently patented by Accenture Global Services GmbH is instructive on how certification programs can work. See U.S. Pat. No. 6,990,465 (Jan. 24, 2006) (“system for establishing preferred business partners using a vendor certification program offered via a communications network”) (“465 patent”). The '465 patent covers an online curriculum and certification program for affiliates of a product manufacturer. After completing the program, the affiliate is conferred “preferred status with respect to its relationship with the manufacturer.” Id. at 9. The program participants gain from enhanced business opportunities and the manufacturer gains from having affiliates who are demonstrably well versed in the manufacturer's products or services. As discussed below, with the present invention, a plurality of program vendors benefit in ways not otherwise available to them outside the program.

### BRIEF SUMMARY

The preferred embodiment of the present invention relate to a method and system for providing owners of investment personal property with an efficient, secure, and financially attractive means of acquiring new property that is of like character. The preferred embodiments create a certification program based, in part, on the availability of optional “black box” insurance products coupled with a custom classification and information distribution method, removes the drawbacks and disadvantages typically faced when exchanging like-kind fine art and collectibles and enhances the likelihood that such an exchange will have a favorable tax outcome. As well, once “certified” pursuant to the present invention, objects owned by the top end of the fine art and collectible “food chain”—super-affluent collectors and museums—will have greatly enhanced opportunities to exchange their fine art and collectible property for like property. Although it is anticipated that gallery owners and antique dealers may be active users of the certification program, such use will primarily be done as agents on behalf of collectors and museums rather than as direct participants.

One cornerstone of the preferred embodiments is the stringent nature of the membership requirements necessary to participate in the certification program. Although “trading posts” have been around since the first town squares were formed thousands of years ago, there has never been any requirement of exclusivity that potentially limited the exchange of property. In fact, having an exclusivity requirement would have been contrary to the best interests of the participants given that they thrived on transaction volume.

The preferred embodiments dictate that only pre-screened applicants meeting certain financial and ethical criteria can become a member. Moreover, in one embodiment, a member can, for example, only be allowed to list with the certification program a piece of modern sculpture valued at $50,000 or more. Simply put, unlike the open approach used by “online transaction aggregators” such as eBay, Inc., the preferred embodiments require a high level of exclusivity in order to adequately function.

An object of at least one of the preferred embodiments is to provide a system that facilitates the creation of a comprehensive database of available fine art and collectibles referenced by subject matter and theme as well as by physical description.

Another object of at least one of the preferred embodiments is to streamline the underwriting process and minimize premium for a tax indemnification insurance policy that indemnifies against the disqualification of an investment property exchange undertaken pursuant to IRS Section 1031.

Another object of at least one of the preferred embodiments is to streamline the underwriting process and minimize premium for a fine art and collectible property insurance policy.

Another object of at least one of the preferred embodiments is to streamline the underwriting process and minimize premium for a title insurance policy for fine art and collectibles.

Another object of at least one of the preferred embodiments is to improve upon the appraisal of fine art and collectibles by digitally aggregating data and creating uniformity in valuations of like objects and those objects with a common character.

Another object of at least one of the preferred embodiments is to provide users of the present invention with a means of storing digital appraisals of certain items of their collection.

Another object of at least one of the preferred embodiments is to improve upon the pool of potential personal investment property objects by increasing the likelihood a super-affluent collector would be willing to disclose to others his or her collecting interests as well as the actual pieces within his or her collection.

### DESCRIPTION OF THE FIGURES

The figures illustrate one embodiment contemplated for carrying out the present invention.

FIG. 1 illustrates the member application process for gaining access to the certification program, in accordance with one embodiment of the present invention.

FIG. 2 illustrates the listing certification process of the certification program, in accordance with the one embodiment of the present invention.

FIG. 3 illustrates the process for obtaining a certified appraisal under the certification program, in accordance with one embodiment of the present invention.

FIG. 4 illustrates the process for obtaining certified property insurance under the certification program, in accordance with one embodiment of the present invention.

FIG. 5 illustrates the process for obtaining certified title insurance under the certification program, in accordance with one embodiment of the present invention.

FIG. 6 illustrates the exchange process of the certification program, in accordance with one embodiment of the present invention.

FIG. 7 illustrates the process for obtaining certified tax indemnity insurance under the certification program, in accordance with one embodiment of the present invention.

FIG. 8 illustrates the physical transfer process under the certification program, in accordance with one embodiment of the present invention.

### DETAILED DESCRIPTION OF THE PREFERRED EMBODIMENTS

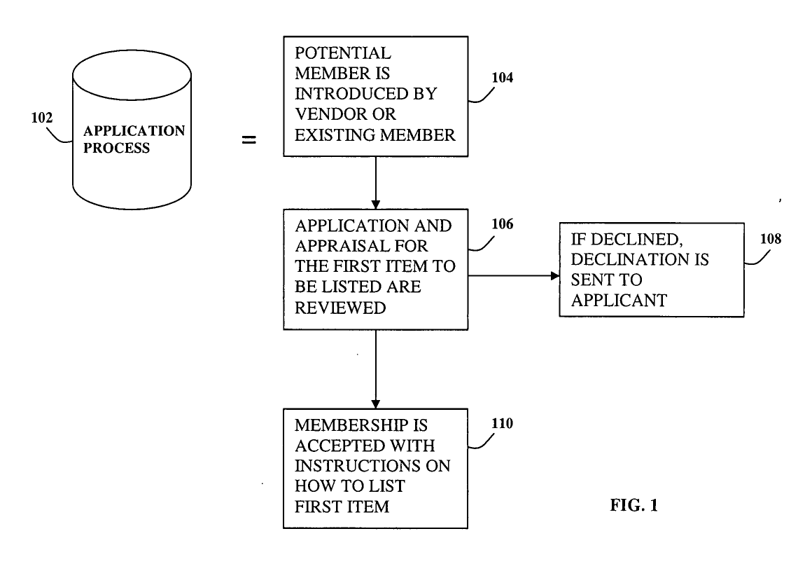

The following detailed description, which is described with reference to FIGS. 1-8, is given by way of example and is not intended to limit the embodiments of the present invention. For example, one embodiment of the present invention may only allow listing of antique furniture in the certification program. Although a large universe of investment personal property and capital assets exists, a certification program in this embodiment may be limited to only specific categories of items.

FIG. 1 depicts the initial step in the acquisition of objects for inclusion in the certification program, namely the application process 102. The first step in the application process 104 requires that an existing member or a vendor partner such as an insurance broker, an insurer, a law firm, or a banker introduce the potential member to the service. If after a review by the certification program 106 the application and initial item's appraisal do not meet the criteria set by the certification program managers, the application is rejected 108 and a declination is sent out to the applicant.

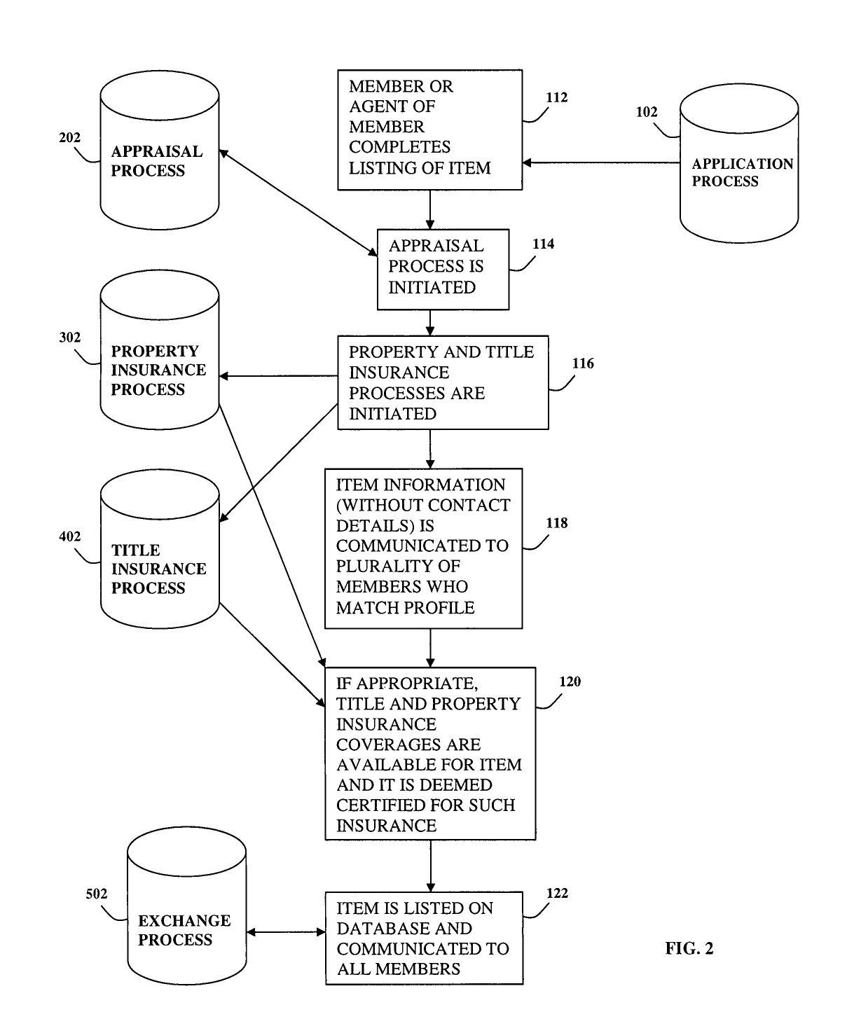

If the membership is accepted 110, the item is listed 112. In one embodiment of the present invention the program managers actually obtain ownership in the listed item and the former owner will have 45 days in which to identify a suitable item for exchange. As illustrated in FIG. 2, the item is listed with certain details on a database that can be viewed only by the program managers 112 and the various appraisal 114 and insurance 116 processes are initiated. While these processes are undertaken, the matching process is initiated 118 by ensuring that appropriate members find out about the item that will soon be formally listed.

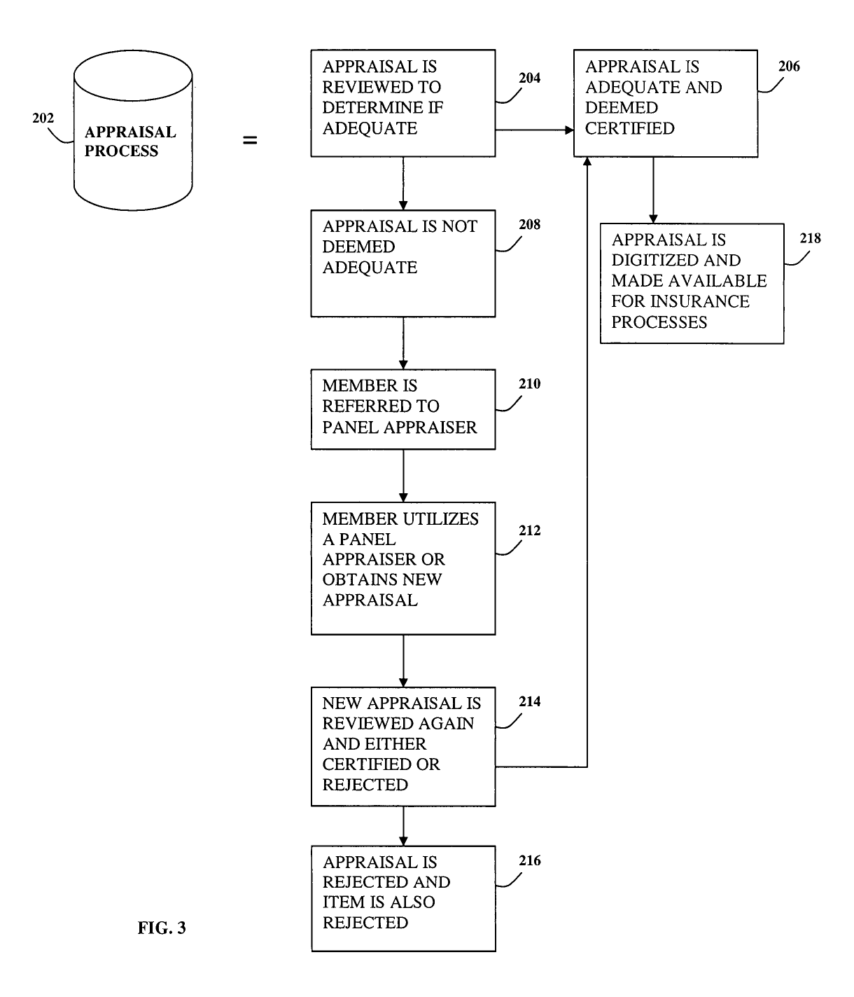

The appraisal process 202 illustrated within FIG. 3 ensures that an adequate appraisal is obtained for the program. By way of example, this embodiment would utilize an appraisal grid, in digital format, listing the following information needed for the appraised item:
i. Title (if any) and name of the artist, creator or manufacturer (if known) or attributed school
ii. Signature or markings
iii. Age (if known)
iv. Actual price paid, or basis
v. Recent appraisal(s)
vi. Provenance (ownership history), including where bought or from whom and prior ownership lineage.
vii. Description of object and what it is made out viii. Theme of object (keyword driven descriptors)
ix. Dimensions (height, width, length) and weight
x. Condition
xi. Photographs
xii. Whether item been publicly displayed at an exhibition or included in any printed or on-line material
xiii. Information about owner

If the provided information is insufficient or the appraisal equivocates on whether the item is of a certain value or quality, the submitted appraisal may be deemed inadequate 208. If it is adequate, it is deemed certified by the program 206, and is digitized and made available for the insurance processes 218. An inadequate appraisal requires that the approved member be referred to an approved panel appraiser 210 and must either use this approved panel appraiser or obtain a new appraisal 212. This new appraisal is reviewed again and is either certified as acceptable or rejected 214. If the appraisal is rejected again, the item is rejected 216. Given that the application was accepted, the member can try and submit another item.

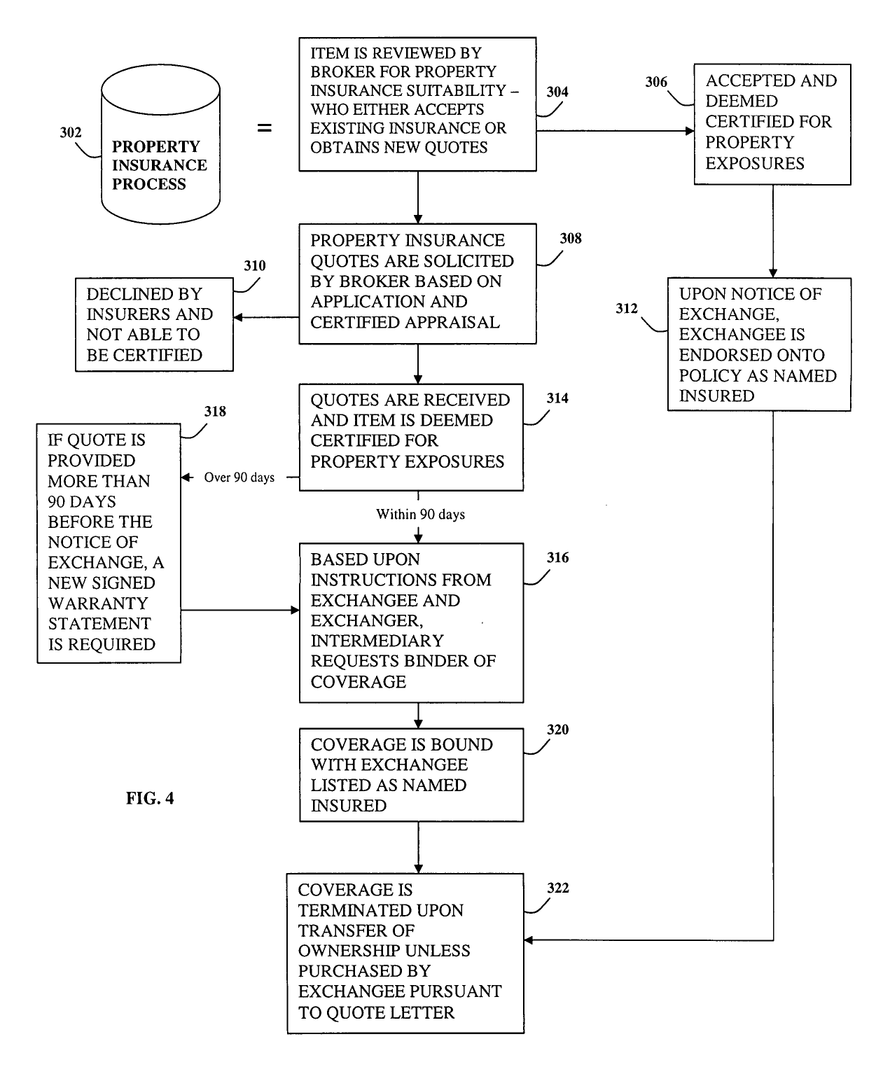

The property insurance process illustrated by FIG. 4 begins by having the item's appraisal and application reviewed by a broker who may or may not be and investor in the program 304. As with all of the program vendor participants, the brokers may either be partial owners of the certification program or act strictly as third-party vendors with no investment relationship tied to the program. To the extent vendors are part owners, they will be precluded from owning more than 10% of the business entity that owns the certification program. This cap is required to ensure that the program can also act as a qualified intermediary under IRS Section 1031.

Property insurance quotes would be solicited 308 if the item were not already adequately insured with wall-to-wall transportation loss coverage and other required property insurance. If the item has adequate insurance, it would be immediately certified for property exposures 306. Acknowledging the inchoate rights of the exchangees, i.e., those looking to exchange property with the owners/exchangers, he or she would be listed as an additional named insured in the policy 312. Such first-party coverage would be unique to the present invention and not something currently available on the market given that the exchangee has no existing ownership interest in the item. In effect, upon a “notice of exchange” signaling an acceptable exchange between exchangee and exchanger, the two parties are treated nearly identically for purposes of insurance coverage under the present invention. Moreover, unlike traditional scheduled property coverage, the coverage procured under the preferred embodiment of the present invention would entail having the property coverage primarily to protect against loss during transportation of the object. Given that such loss is probably the greatest exposure to fine art and collectibles, a means to reduce the premium will be required.

One embodiment of the present invention would contain a feature that reduces premium due to a tie-in limits endorsement triggered between the various policies. For example, if the item is all at once lost in transit, determined to be stolen, and is disqualified for an IRS Section 1031 exchange, the insureds would have access to a single aggregate policy limit rather than three. In return, the premium would reflect such limitation in potential policy limits. The policies would determine which limit would sit excess over the next by virtue of when and how the losses took place.

As illustrated in FIG. 4, insurers solicited for quotes may decline to provide coverage and the item would continue to lack certification for property coverage 310. If acceptable quotes are received, 314 it is deemed certified for property insurance. Depending on whether the notice of exchange is received within 90 days of the receipt of the quotes, the exchanger or program intermediary (if title has been transferred to the intermediary to create a deferred like-kind exchange), may be required to provide a warranty statement indicating that no material change has occurred since the time of the application 318 or, if under 90 days, the quotes can be bound without any such warranty statement 316. After coverage is bound 320, it lasts as long as the new owner chooses to keep it on or decides to remove it 322.

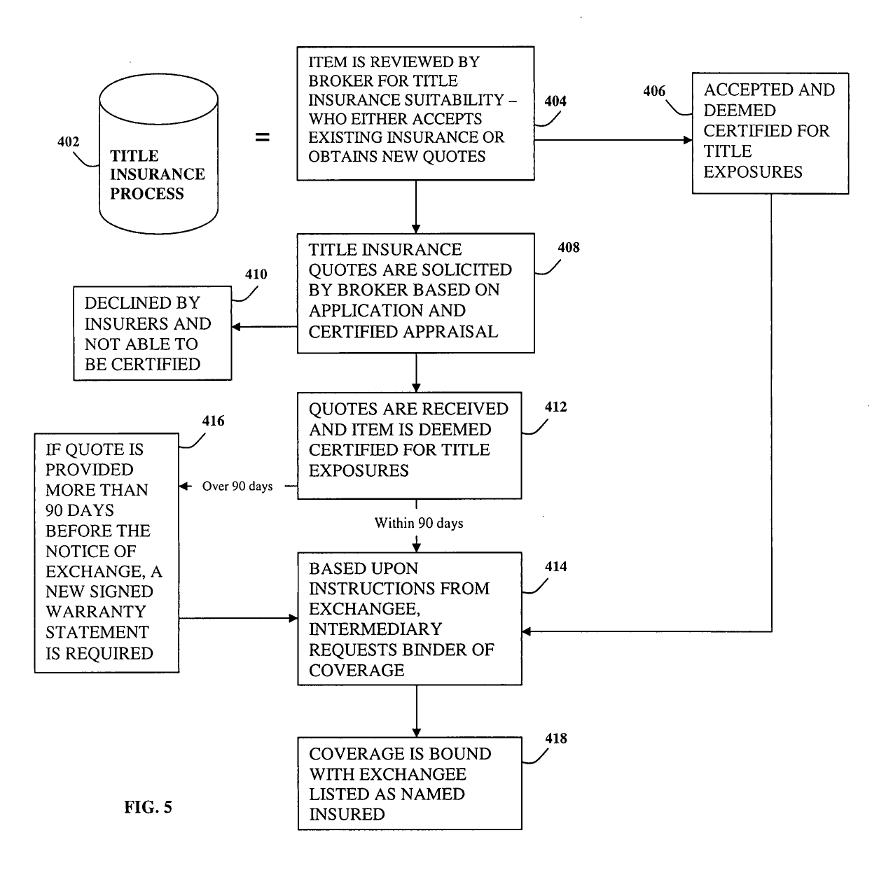

A similar process would take place for the procurement of title insurance 402. FIG. 5 illustrates the title insurance review process 404. It is possible that the item has existing and acceptable title insurance. If so, the item would be deemed certified for title exposures 406. As illustrated in FIG. 5, insurers solicited for quotes may decline to provide coverage and the item would continue to lack certification for property coverage 410. If acceptable quotes are received, 408 the item is deemed certified for title insurance 412. Depending on whether the notice of exchange is received within 90 days of the receipt of the quotes, the exchanger or program intermediary may be required to provide a warranty statement indicating that no material change has occurred since the time of the application 416 or, if under 90 days, the quotes can be bound without any such warranty statement 414. In one embodiment of the present invention, coverage would be bound 418 with the exchangee listed as the sole named insured.

As with the property insurance, the title insurance underwriting is “black box” in approach with the application warranty questions concerning ownership history and provenance and the appraisal constituting the key underwriting components. In one embodiment of the present invention, the pricing is based on a predetermined percentage of the appraised replacement value. Moreover, in order to get preferential pricing, the insurers are afforded an opportunity to exchange a lost, stolen, damaged, or “bad title” piece with another one of like character. Only if no available piece is deemed suitable to the parties will a cash reimbursement on the loss be made. Given that the major title exposure not easily “black box” underwritten will derive from a repatriation Claim, there may be antiquities exclusionary language built into the coverage.

As illustrated by FIG. 2, once the item completes the appraisal 202, property insurance 302, and title insurance 402 processes the item will be certified as appropriate 120 and fully listed on a database available to all members 122 and the exchange process is initiated 502.

In the preferred embodiment of the present invention, the database server can be queried by exchangees to search for particular items of interest based on not only the attributes of the object itself, i.e., bronze sculpture, but also on the theme of the object, i.e., cowboy or western theme, “tagged” by the person inputting the item. By way of example, a Frederic Remington bronze sculpture of a cowboy riding a horse could possibly be matched by a Western landscape painting by Albert Bierstadt or a rare set of Winchester rifles.

In the preferred embodiment of the present invention, information about items available for exchange should be kept anonymous unless requested by an exchangee and agreed to be released by the exchanger. Once an exchangee accesses the database, a list of items meeting the search criteria will be retrieved from the storage medium and displayed for viewing on the exchangee's display device.

In one embodiment of the present invention, the front-end of the application is constructed so that the information about the items available for licensing are accessible in successive layers, with each successive layer revealing more detailed information than the preceding layers. Specifically, at a first level, exchangees can access the titles to and brief descriptions of items that satisfy their search criteria as well as all available photographs. After demonstrating that he or she has an item of comparable value, the exchangee can obtain additional information such as more detailed textual and graphical information regarding the item of interest.

The preferred embodiment is implemented using hardware and software that can be written using multiple programming languages. The preferred embodiment can be used on a global or local computer network, on a personal computer, on a broadband wireless telephone, on a portable communication device such as a Blackberry®, or on any other hard-wired or wireless device that enables digitally stored information to be viewed and transmitted. Also, information displayed and viewed should be able to be printed, stored on or to other storage medium, and electronically mailed. The key component to any implementation of the database is that it is easily accessible to members but still employs the strongest level of security commercially available, including but not limited to virtual private networks, SSL security and dual password protection.

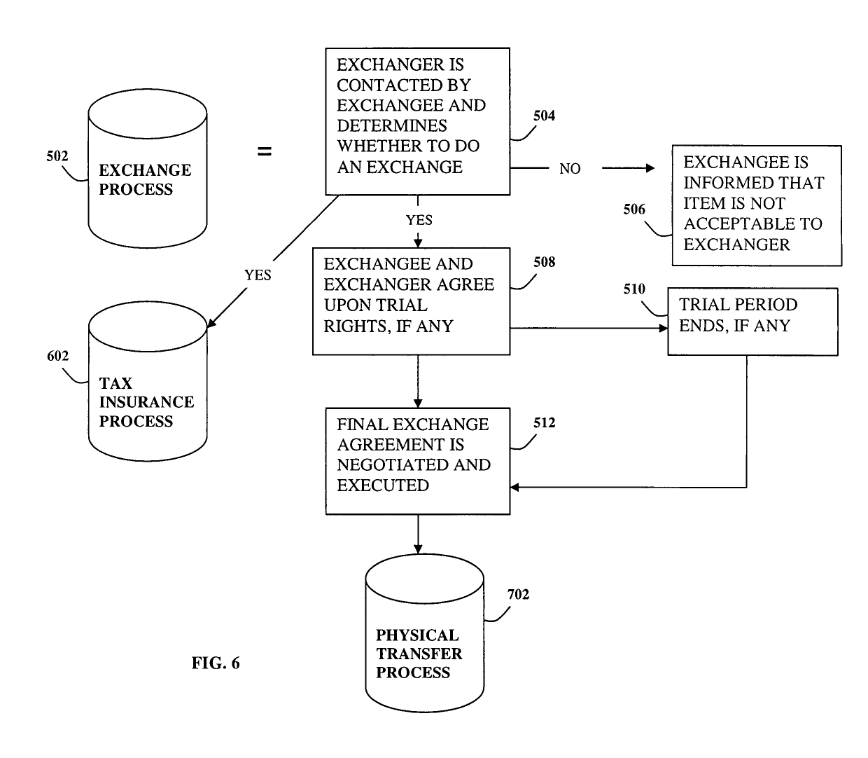

The actual exchange process 502 is depicted in FIG. 6 of the drawings. After viewing the item, a potential exchangee contacts the exchanger and the both determine whether to enter into an exchange 504. One obvious potential result is that the exchanger does not find the item being offered as suitable 506. If the item is deemed suitable, however, the tax insurance process 602 is initiated and the exchangee and exchanger must agree upon a trial period, if any 508. This trial period would allow the potential exchanging parties to view the items in question for a period of time in a location of their choosing. Although provided by the program, each party would pay for their respective transportation, insurance, and other associated costs, including but not limited to security, during the trial period.

After the trial period is completed 510, the final exchange agreement will be negotiated 512. Some of the terms to be negotiated include how the physical transfer process 702 is to be conducted and their respective obligations regarding the tax insurance that will be procured pursuant to the tax liability insurance process 602.

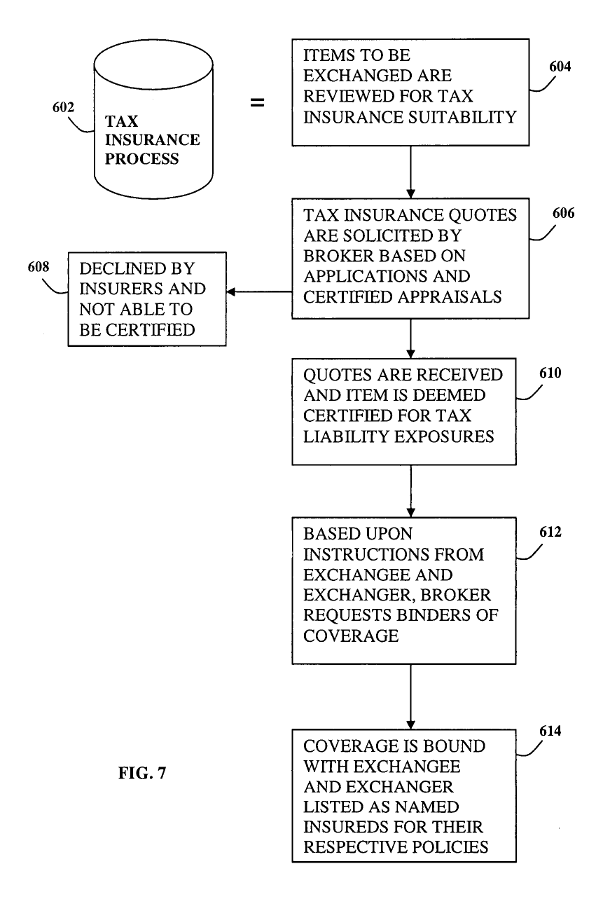

As depicted in FIG. 7, the tax insurance process 602 begins by an evaluation of the items to be exchanged. A determination must be made to see if they are of sufficient like character to be suitable for an IRS Section 1031 exchange. This is done using the classification system created under the present invention and is an automated process 604. If appropriate, quotes are solicited from insurers 606 and after being received the items will be certified for tax liability insurance 610. If declined by insurers, the items will lack such certification 608. The exchangee and exchanger must choose whether to bind coverage 612 and each will have their own policy if coverage is bound 614. Moreover, given that there is an automatic step-up in the basis of investment property upon the death of the owner, the insurance will have a means to factor into the premium the life expectancy of the owner.

Again, the underwriting will be “black box” rather than the typical underwriting approach for a tax liability insurance product. For example, the typical tax indemnity policy has significant underwriting costs and time delays associated with them. The underwriting will take into account whether the items are of like character and the respective differences between the basis and appraised fair market when calculating a premium. As well, where the property was predominately used during the two-year period ending on the date of the exchange will be taken into consideration given certain requirements found in IRS Section 1031. Finally, the fact that one of the participants may be a non-for profit institution may factor into the risk analysis. Moreover, the insurance procured as well as appraisal costs would be factored into the risk analysis given they would be exchange expenses that would offset the basis should the transaction not be considered like kind in nature.

In the preferred embodiment of the present invention, the certification program determines the premium amounts for all insurance products, including this tax liability product, and solicits quotes from those insurers willing to write the business with such predetermined pricing already in place.

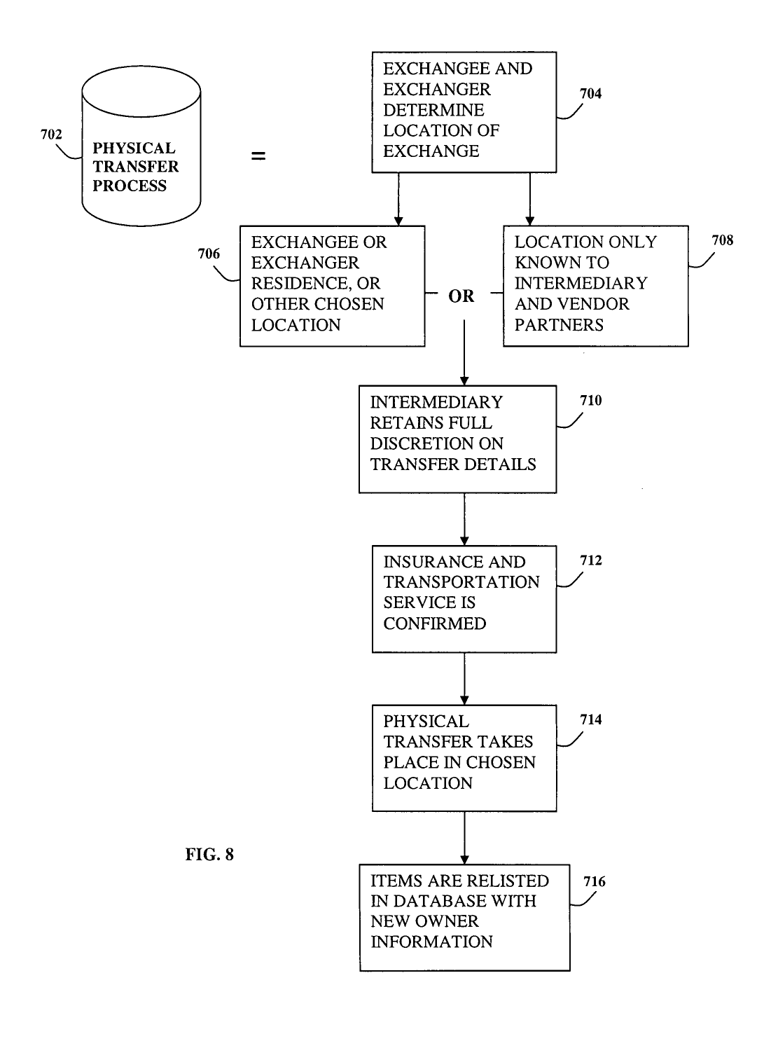

The physical transfer process depicted in FIG. 8 illustrates that the exchange parties can choose the location of the exchange 704. It can be done either at one of the party's residence 706 or at a location only known to the program intermediary and the program vendors 708. In either case, the intermediary retains full control of the exchange 710. After the insurance and transportation is properly confirmed 712, the physical transfer takes place 714 and the items are listed again in the database with the new owner information 716.

Numerous modifications to and alternative embodiments of the present invention will be apparent to those skilled in the art in view of the foregoing description. Accordingly, this description is to be construed as illustrative only and is for the purpose of teaching those skilled in the art the best mode of carrying out the present invention. Details of the structure may be varied substantially without departing from the spirit of the present invention and the exclusive use of all modifications, which come within the scope of the Claims to be filed, is hereby reserved.

What is claimed is:

1. A method for obtaining information that leads to the acquisition of certified personal investment property for a tax-beneficial exchange, comprising the steps of:
accessing a web site listing a plurality of like items available for exchange;
selecting at least one item of said plurality of like items for viewing;
displaying said at least one item on a display device for viewing; and
acquiring said at least one item as a certified personal investment property for a tax-beneficial exchange.

2. The method according to claim 1, wherein a first layer provides a title and a registration number for said at least one item.

3. The method according to claim 1, wherein a second layer provides a textual description, including initial appraisal information, and a graphical representation of the one item.

4. The method according to claim 1, wherein a third layer provides further appraisal information and information concerning exchange requirements and available insurance coverages.

5. The method according to claim 1, further comprising protecting the anonymity of a plurality of transaction parties by only passing data required for identification of the item together with an identification token.

6. A system for obtaining information regarding certified investment personal property available for exchange, comprising:
a communications network; and
a network-enabled device, said network-enabled device configured to:
communicate via said communications network;
search a plurality of certified items available for exchange, select at least one of said plurality of certified items;
retrieve said at least one item from a storage medium;
display said at least one item for viewing, and
acquire said at least one item as certified personal investment property for a tax-beneficial exchange.

7. The system according to claim 6, wherein the items can be searched on a web site over the Internet based on a heuristic taxonomy developed to provide matches based on common themes as well as descriptions.

8. The system according to claim 6, wherein the system periodically sends an electronic message regarding a recently registered item of interest to a particular recipient based on criteria provided by the particular recipient.

9. The system according to claim 6, wherein information regarding at least one item is accessible for viewing on the display device in successive layers, each layer providing more detailed information about the item.

10. The system according to claim 6, wherein a first layer provides a title and a registration number for at least item.

11. The system according to claim 6, wherein a second layer provides a textual description, including initial appraisal information, and a graphical representation of the one item.

12. The system according to claim 6, wherein a third layer provides further appraisal information and information concerning exchange requirements and available insurance coverages.

13. A method for a prospective personal investment property exchangee to access information regarding items available for exchange over the Internet, comprising the steps of:
accessing a web site providing information regarding a plurality of items available for exchange;
searching the web site for at least one item of interest;
viewing a title and brief description of the at least one item of interest on a display device;
providing identifying information regarding the prospective exchanging party;
viewing detailed textual information and graphical representation regarding at least one item of interest on the display device;
paying a fee to the entity providing the information; and
viewing licensor contact information for at least one item of interest on the display device.

14. The method according to claim 13, wherein information regarding at least one item of interest is obtained via a computer.

15. The method according to claim 13, wherein information regarding at least one item of interest is obtained via a wireless device.

16. A method to locate investment personal property exchangees, the method comprising:
providing a certification program comprising a communication network on a fee basis; and
electronically receiving a notification, from an entity administering the certification program that an item has been certified and is available for exchange.

17. The method of claim 16, wherein the certification is based on the availability of an insurance product to mitigate against an adverse tax event.

18. The method of claim 16, wherein the certification is based on the availability of insurance to mitigate against property loss.

19. The method of claim 16, wherein the certification is based on the availability of insurance to mitigate against adverse title or false provenance.

20. The method of claim 16, wherein the certification is based on an approved appraisal.

21. The method of claim 16, wherein the certification is based on the availability of preferred vendors providing services for users of the certification program.

22. The method of claim 16, further comprising:
undertaking an acquisition decision;
accessing information regarding a plurality of vendors, the plurality of vendor comprising at least one vendor having certified vendor status.

23. The method of claim 16, further comprising providing the certification program, at least in part, via a public communication network.

24. The method of claim 16, further comprising providing the certification program, at least in part, via a private communication network.

25. A method, via a communication network, for a member to obtain preferred access to investment personal property, the method comprising:
electronically registering for a fee-based certification program provided by the entity, wherein the certification program comprises a database utilizing parsed and searchable data that includes non-traditional metadata regarding the item;
successfully locating a suitable item via the communication network; and
receiving, from the entity, a notification of the transfer process and available protections afforded to mitigate against the risks inherent in the exchange.

26. The method of claim 25, wherein the certification process is commensurate with the expertise possessed by the vendor affiliates who constitute the entity.

27. The method of claim 25, wherein the entity comprises a plurality of professional vendors who are in the professional services sector, including those utilizing wealth management services and fine arts and collectibles vendor services.

28. The method of claim 25, further comprising successfully utilizing the certification program, at least in part, via a public communication network.

29. The method of claim 25, further comprising successfully utilizing the certification program, at least in part, via a private communication network.

30. A system whereby an entity establishes relationships with vendors via a communication network, the system comprising:
an electronic management component, operatively coupled to the communication network, that administers a certification program on behalf of an entity; and
at least one database, coupled to the management component, comprising information indicating that an item has certified status and is available for exchange.

31. The system of claim 30, wherein the certification process is commensurate with the expertise possessed by the vendor affiliates who constitute the entity.

32. The system of claim 30, further comprising: a financial transaction component, coupled to the management component that handles payments to the certification program vendors for participation in the certification program.

33. The system of claim 30, wherein the network interface communicates with a public network.

34. The system of claim 30, wherein the network interface communicates with a private network.

35. A method for determining a premium of an insurance policy for the tax indemnification of an exchange of investment personal property, said method comprising the steps of:
determining potential taxes due for said exchange if the exchange were to be executed in each of a plurality of possible jurisdictions;
determining a plurality of taxable event scenarios, wherein each scenario is based on the applicability of various local, state, federal and non-US tax laws as well as different appraised valuation of the object post-exchange, and wherein each scenario has a monetary sum;
determining a risk transfer element for each said scenario, said risk transfer element the unexpected tax results multiplied by a probability of actual occurrence;
determining insurer expenses for each said scenario, said insurer expenses being the present value of expected losses; and
adding the monetary value of these steps, for each scenario, and to calculate said monetary sum of each said scenario,
wherein said premium of said insurance policy is based on the adjusted sum and wherein this calculation is performed with a computer.

36. The method of claim 35, comprising the step of determining said premium based on the sum of said adjusted sum and an insurance profit value.

37. The method of claim 35, further comprising determining said premium by calculating any shipping costs due to execution of the exchange in each of the plurality of preferred jurisdictions.

38. The method according to claim 35, further comprising determining any tariffs due if the given transaction were executed in each of the plurality of possible jurisdictions.

39. The method according to claim 35, further comprising any additional costs incurred if the transaction is executed in the selected jurisdiction.

40. The method according to claim 35, further comprising enabling the exchangee and exchanger to select in which one of the plurality of possible jurisdictions to have the physical exchange of the item.

41. The method according to claim 35, further comprising ranking each of the jurisdictions based on the determination of potential taxes for the exchange.

42. The method of claim 35, wherein the self-insured retention or deductible is the amount determined to be equivalent to the expected insurer expense.

43. The method of claim 35, wherein said insurance policy is an existing insurance policy between said policy inception and termination dates.
